(19) United States
(12) Patent Application Publication
(10) Pub. No.: US 2025/0234241 A1
(43) Pub. Date: Jul. 17, 2025

(54) SYSTEMS AND METHODS OF TRAFFIC IDENTIFIER TO LINK MAPPING

(71) Applicant: Meta Platforms Technologies, LLC, Menlo Park, CA (US)

(72) Inventors: Muhammad Kumail Haider, Sunnyvale, CA (US); Guoqing Li, Cupertino, CA (US)

(73) Assignee: Meta Platforms Technologies, LLC, Menlo Park, CA (US)

(21) Appl. No.: 18/977,700

(22) Filed: Dec. 11, 2024

Related U.S. Application Data
(60) Provisional application No. 63/620,003, filed on Jan. 11, 2024.

(51) Int. Cl. H04W 28/02; H04L 47/24

(52) U.S. Cl. CPC H04W 28/0268; H04L 47/24

(57) ABSTRACT

Systems and methods for adaptive frequency hopping may include a first multi-link device (MLD) which identifies a first traffic stream associated with a first set of quality of service (QoS) parameters and a second traffic stream associated with a second set of QoS parameters. The first multi-link device may map the first set of QoS parameters to one or more first links of a plurality of links between the first MLD and a second MLD, and the second set of QoS parameters to one or more second links of the plurality of links. The first multi-link device may communicate the first traffic stream over the one or more first links during a service period (SP) of a target wake time (TWT) schedule. The first multi-link device may communicate the second traffic stream over the one or more second links.

### CROSS-REFERENCE TO RELATED APPLICATIONS

This application claims the benefit of and priority to U.S. Provisional Application No. 63/620,003, filed Jan. 11, 2024, the contents of which are incorporated herein by reference in their entirety.

### FIELD OF DISCLOSURE

The present disclosure is generally related to multi-link operation (MLO), including but not limited to, systems and methods for traffic identifier to link mapping.

### BACKGROUND

Augmented reality (AR), virtual reality (VR), and mixed reality (MR) are becoming more prevalent, which such technology being supported across a wider variety of platforms and devices. Some AR/VR/MR devices may communicate with other devices within an environment, where such communication is provided via a channel or link between the devices. As part of establishing the connection, the devices may identify availability of the channel or link.

### SUMMARY

Various embodiments disclosed herein relate to a method including identifying, by a first multi-link device (MLD), a first traffic stream associated with a first set of quality of service (QoS) parameters and a second traffic stream associated with a second set of QoS parameters. The method may include mapping, by the first MLD, the first set of QoS parameters to one or more first links of a plurality of links between the first MLD and a second MLD, and the second set of QoS parameters to one or more second links of the plurality of links. The method may further include communicating, by the first MLD, the first traffic stream over the one or more first links during a service period (SP) of a target wake time (TWT) schedule and communicating, by the first MLD, the second traffic stream over the one or more second links.

In some examples, the first set of QoS parameters may relates to latency sensitive traffic. In these examples, the second set of QoS parameters relates to traffic other than latency sensitive traffic. In other examples, the first set of QoS parameters may include a bandwidth different from a bandwidth included in the second set of QoS parameters or periodicity different from periodicity included in the second set of QoS parameters.

In some embodiments, the first MLD may include an access point (AP) MLD, and the second MLD may include a non-AP MLD. In an alternative embodiment, the first MLD may include a non-AP MLD, and the second MLD may include an AP MLD. In yet another alternative embodiment, each of the first MLD and the second MLD may comprise a non-AP MLD.

In some examples, the one or more first links may be a single link of the plurality of links. In some examples, the one or more second links include two or more links of the plurality of links.

In some embodiments the first set of QoS parameters may be associated with one or more first traffic identifier (TIDs). The second set of QoS parameters may be associated with one or more second TIDs.

In some embodiments, mapping the first set of QoS parameters to the one or more first links may include associating the first set of QoS parameters with a TWT schedule. Mapping the first set of QoS parameters to the one or more first links may also include performing a TID to link mapping (TTLM) procedure to map the one or more first TIDs to the one or more first links. In some embodiments, one or more of the second links may be maintained in active mode.

In some embodiments, the techniques described herein relate to a method, wherein mapping the first set of QoS parameters to the one or more first links includes: performing a stream classification service (SCS) procedure to associate the first set of QoS parameters with the one or more first TIDs.

In some examples, the one or more first TIDs may be a single TID. In some examples, the one or more second TIDs include two or more TIDs.

In some embodiments, the method may include determining whether the second traffic stream has an interval smaller than a threshold. In these embodiments, the method may further include identifying the second traffic stream associated with the second set of QoS parameters in response to the second traffic stream having an interval smaller than the threshold.

In another aspect, the techniques described herein relate to a first multi-link device (MLD) including one or more processors configured to identify a first traffic stream associated with a first set of quality of service (QoS) parameters and a second traffic stream associated with a second set of QoS parameters. The MLD may be configured to map the first set of QoS parameters to one or more first links of a plurality of links between the first MLD and a second MLD, and the second set of QoS parameters to one or more second links of the plurality of links. The MLD may be further configured to communicate the first traffic stream over the one or more first links during a service period (SP) of a target wake time (TWT) schedule and communicate the second traffic stream over the one or more second links.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of an example wireless communication system, according to an example implementation of the present disclosure.

FIG. 2 is a diagram of a console and a head wearable display for presenting augmented reality or virtual reality, according to an example implementation of the present disclosure.

FIG. 3 is a diagram of a head wearable display, according to an example implementation of the present disclosure.

FIG. 4 is a block diagram of a computing environment according to an example implementation of the present disclosure.

FIG. 5 is an example system utilizing multiple links, according to an example implementation of the present disclosure.

FIG. 6 is a diagram of data types mapped to links, according to an example implementation of the present disclosure.

FIG. 7 is another diagram of data types mapped to links, according to an example implementation of the present disclosure.

FIG. 8 is a timing diagram showing a wake-up/sleep schedule of a computing device utilizing TWT, according to an example implementation of the present disclosure.

FIG. 9 is a timing diagram showing a system configuring a data type to be sent over a link, according to an example implementation of the present disclosure.

FIG. 10 is a flowchart showing an example method of traffic identifier to link mapping, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

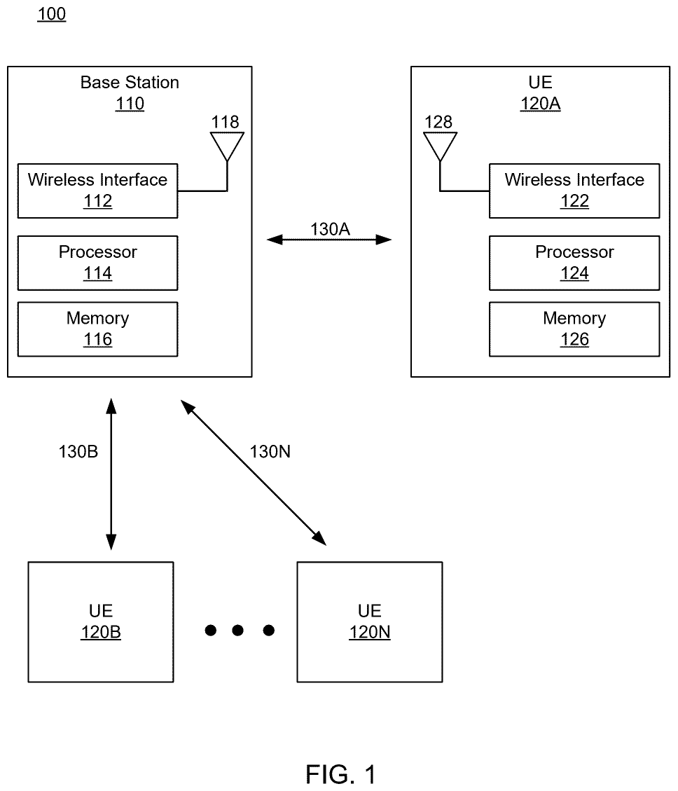

FIG. 1 illustrates an example wireless communication system 100. The wireless communication system 100 may include a base station 110 (also referred to as “a wireless communication node 110” or “a station 110”) and one or more user equipment (UEs) 120 (also referred to as “wireless communication devices 120” or “terminal devices 120”). The base station 110 and the UEs 120 may communicate through wireless commination links 130A, 130B, 130C. The wireless communication link 130 may be a cellular communication link conforming to 3G, 4G, 5G or other cellular communication protocols or a Wi-Fi communication protocol. In one example, the wireless communication link 130 supports, employs or is based on an orthogonal frequency division multiple access (OFDMA). In one aspect, the UEs 120 are located within a geographical boundary with respect to the base station 110, and may communicate with or through the base station 110. In some embodiments, the wireless communication system 100 includes more, fewer, or different components than shown in FIG. 1. For example, the wireless communication system 100 may include one or more additional base stations 110 than shown in FIG. 1.

In some embodiments, the UE 120 may be a user device such as a mobile phone, a smart phone, a personal digital assistant (PDA), tablet, laptop computer, wearable computing device, etc. Each UE 120 may communicate with the base station 110 through a corresponding communication link 130. For example, the UE 120 may transmit data to a base station 110 through a wireless communication link 130, and receive data from the base station 110 through the wireless communication link 130. Example data may include audio data, image data, text, etc. Communication or transmission of data by the UE 120 to the base station 110 may be referred to as an uplink communication. Communication or reception of data by the UE 120 from the base station 110 may be referred to as a downlink communication. In some embodiments, the UE 120A includes a wireless interface 122, a processor 124, a memory device 126, and one or more antennas 128. These components may be embodied as hardware, software, firmware, or a combination thereof. In some embodiments, the UE 120A includes more, fewer, or different components than shown in FIG. 1. For example, the UE 120 may include an electronic display and/or an input device. For example, the UE 120 may include additional antennas 128 and wireless interfaces 122 than shown in FIG. 1.

The antenna 128 may be a component that receives a radio frequency (RF) signal and/or transmit a RF signal through a wireless medium. The RF signal may be at a frequency between 200 MHz to 100 GHz. The RF signal may have packets, symbols, or frames corresponding to data for communication. The antenna 128 may be a dipole antenna, a patch antenna, a ring antenna, or any suitable antenna for wireless communication. In one aspect, a single antenna 128 is utilized for both transmitting the RF signal and receiving the RF signal. In one aspect, different antennas 128 are utilized for transmitting the RF signal and receiving the RF signal. In one aspect, multiple antennas 128 are utilized to support multiple-in, multiple-out (MIMO) communication.

The wireless interface 122 includes or is embodied as a transceiver for transmitting and receiving RF signals through a wireless medium. The wireless interface 122 may communicate with a wireless interface 112 of the base station 110 through a wireless communication link 130A. In one configuration, the wireless interface 122 is coupled to one or more antennas 128. In one aspect, the wireless interface 122 may receive the RF signal at the RF frequency received through antenna 128, and downconvert the RF signal to a baseband frequency (e.g., 0˜1 GHz). The wireless interface 122 may provide the downconverted signal to the processor 124. In one aspect, the wireless interface 122 may receive a baseband signal for transmission at a baseband frequency from the processor 124, and upconvert the baseband signal to generate a RF signal. The wireless interface 122 may transmit the RF signal through the antenna 128.

The processor 124 is a component that processes data. The processor 124 may be embodied as field programmable gate array (FPGA), application specific integrated circuit (ASIC), a logic circuit, etc. The processor 124 may obtain instructions from the memory device 126, and executes the instructions. In one aspect, the processor 124 may receive downconverted data at the baseband frequency from the wireless interface 122, and decode or process the downconverted data. For example, the processor 124 may generate audio data or image data according to the downconverted data, and present an audio indicated by the audio data and/or an image indicated by the image data to a user of the UE 120A. In one aspect, the processor 124 may generate or obtain data for transmission at the baseband frequency, and encode or process the data. For example, the processor 124 may encode or process image data or audio data at the baseband frequency, and provide the encoded or processed data to the wireless interface 122 for transmission.

The memory device 126 is a component that stores data. The memory device 126 may be embodied as random access memory (RAM), flash memory, read only memory (ROM), erasable programmable read-only memory (EPROM), electrically erasable programmable read-only memory (EEPROM), registers, a hard disk, a removable disk, a CD-ROM, or any device capable for storing data. The memory device 126 may be embodied as a non-transitory computer readable medium storing instructions executable by the processor 124 to perform various functions of the UE 120A disclosed herein. In some embodiments, the memory device 126 and the processor 124 are integrated as a single component.

In some embodiments, each of the UEs 120B . . . 120N includes similar components of the UE 120A to communicate with the base station 110. Thus, detailed description of duplicated portion thereof is omitted herein for the sake of brevity.

In some embodiments, the base station 110 may be an evolved node B (eNB), a serving eNB, a target eNB, a femto station, or a pico station. The base station 110 may be communicatively coupled to another base station 110 or other communication devices through a wireless communication link and/or a wired communication link. The base station 110 may receive data (or a RF signal) in an uplink communication from a UE 120. Additionally or alternatively, the base station 110 may provide data to another UE 120, another base station, or another communication device. Hence, the base station 110 allows communication among UEs 120 associated with the base station 110, or other UEs associated with different base stations. In some embodiments, the base station 110 includes a wireless interface 112, a processor 114, a memory device 116, and one or more antennas 118. These components may be embodied as hardware, software, firmware, or a combination thereof. In some embodiments, the base station 110 includes more, fewer, or different components than shown in FIG. 1. For example, the base station 110 may include an electronic display and/or an input device. For example, the base station 110 may include additional antennas 118 and wireless interfaces 112 than shown in FIG. 1.

The antenna 118 may be a component that receives a radio frequency (RF) signal and/or transmit a RF signal through a wireless medium. The antenna 118 may be a dipole antenna, a patch antenna, a ring antenna, or any suitable antenna for wireless communication. In one aspect, a single antenna 118 is utilized for both transmitting the RF signal and receiving the RF signal. In one aspect, different antennas 118 are utilized for transmitting the RF signal and receiving the RF signal. In one aspect, multiple antennas 118 are utilized to support multiple-in, multiple-out (MIMO) communication.

The wireless interface 112 includes or is embodied as a transceiver for transmitting and receiving RF signals through a wireless medium. The wireless interface 112 may communicate with a wireless interface 122 of the UE 120 through a wireless communication link 130. In one configuration, the wireless interface 112 is coupled to one or more antennas 118. In one aspect, the wireless interface 112 may receive the RF signal at the RF frequency received through antenna 118, and downconvert the RF signal to a baseband frequency (e.g., 0˜1 GHz). The wireless interface 112 may provide the downconverted signal to the processor 124. In one aspect, the wireless interface 122 may receive a baseband signal for transmission at a baseband frequency from the processor 114, and upconvert the baseband signal to generate a RF signal. The wireless interface 112 may transmit the RF signal through the antenna 118.

The processor 114 is a component that processes data. The processor 114 may be embodied as FPGA, ASIC, a logic circuit, etc. The processor 114 may obtain instructions from the memory device 116, and executes the instructions. In one aspect, the processor 114 may receive downconverted data at the baseband frequency from the wireless interface 112, and decode or process the downconverted data. For example, the processor 114 may generate audio data or image data according to the downconverted data. In one aspect, the processor 114 may generate or obtain data for transmission at the baseband frequency, and encode or process the data. For example, the processor 114 may encode or process image data or audio data at the baseband frequency, and provide the encoded or processed data to the wireless interface 112 for transmission. In one aspect, the processor 114 may set, assign, schedule, or allocate communication resources for different UEs 120. For example, the processor 114 may set different modulation schemes, time slots, channels, frequency bands, etc. for UEs 120 to avoid interference. The processor 114 may generate data (or UL CGs) indicating configuration of communication resources, and provide the data (or UL CGs) to the wireless interface 112 for transmission to the UEs 120.

The memory device 116 is a component that stores data. The memory device 116 may be embodied as RAM, flash memory, ROM, EPROM, EEPROM, registers, a hard disk, a removable disk, a CD-ROM, or any device capable for storing data. The memory device 116 may be embodied as a non-transitory computer readable medium storing instructions executable by the processor 114 to perform various functions of the base station 110 disclosed herein. In some embodiments, the memory device 116 and the processor 114 are integrated as a single component.

In some embodiments, communication between the base station 110 and the UE 120 is based on one or more layers of Open Systems Interconnection (OSI) model. The OSI model may include layers including: a physical layer, a Medium Access Control (MAC) layer, a Radio Link Control (RLC) layer, a Packet Data Convergence Protocol (PDCP) layer, a Radio Resource Control (RRC) layer, a Non Access Stratum (NAS) layer or an Internet Protocol (IP) layer, and other layer.

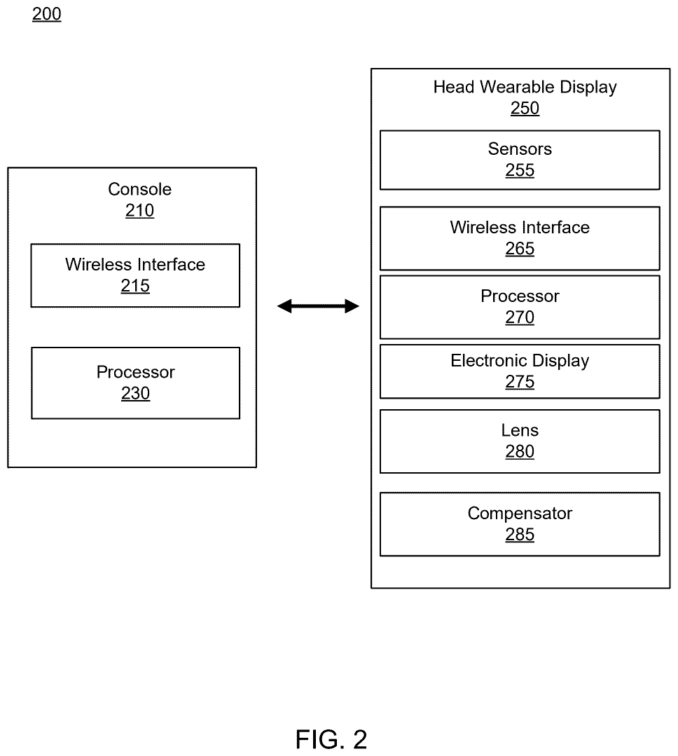

FIG. 2 is a block diagram of an example artificial reality system environment 200. In some embodiments, the artificial reality system environment 200 includes a HWD 250 worn by a user, and a console 210 providing content of artificial reality (e.g., augmented reality, virtual reality, mixed reality) to the HWD 250. Each of the HWD 250 and the console 210 may be a separate UE 120. The HWD 250 may be referred to as, include, or be part of a head mounted display (HMD), head mounted device (HMD), head wearable device (HWD), head worn display (HWD) or head worn device (HWD). The HWD 250 may detect its location and/or orientation of the HWD 250 as well as a shape, location, and/or an orientation of the body/hand/face of the user, and provide the detected location/or orientation of the HWD 250 and/or tracking information indicating the shape, location, and/or orientation of the body/hand/face to the console 210. The console 210 may generate image data indicating an image of the artificial reality according to the detected location and/or orientation of the HWD 250, the detected shape, location and/or orientation of the body/hand/face of the user, and/or a user input for the artificial reality, and transmit the image data to the HWD 250 for presentation. In some embodiments, the artificial reality system environment 200 includes more, fewer, or different components than shown in FIG. 2. In some embodiments, functionality of one or more components of the artificial reality system environment 200 can be distributed among the components in a different manner than is described here. For example, some of the functionality of the console 210 may be performed by the HWD 250. For example, some of the functionality of the HWD 250 may be performed by the console 210. In some embodiments, the console 210 is integrated as part of the HWD 250.

In some embodiments, the HWD 250 is an electronic component that can be worn by a user and can present or provide an artificial reality experience to the user. The HWD 250 may render one or more images, video, audio, or some combination thereof to provide the artificial reality experience to the user. In some embodiments, audio is presented via an external device (e.g., speakers and/or headphones) that receives audio information from the HWD 250, the console 210, or both, and presents audio based on the audio information. In some embodiments, the HWD 250 includes sensors 255, a wireless interface 265, a processor 270, an electronic display 275, a lens 280, and a compensator 285. These components may operate together to detect a location of the HWD 250 and a gaze direction of the user wearing the HWD 250, and render an image of a view within the artificial reality corresponding to the detected location and/or orientation of the HWD 250. In other embodiments, the HWD 250 includes more, fewer, or different components than shown in FIG. 2.

In some embodiments, the sensors 255 include electronic components or a combination of electronic components and software components that detect a location and an orientation of the HWD 250. Examples of the sensors 255 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 255 detect the translational movement and the rotational movement, and determine an orientation and location of the HWD 250. In one aspect, the sensors 255 can detect the translational movement and the rotational movement with respect to a previous orientation and location of the HWD 250, and determine a new orientation and/or location of the HWD 250 by accumulating or integrating the detected translational movement and/or the rotational movement. Assuming for an example that the HWD 250 is oriented in a direction 25 degrees from a reference direction, in response to detecting that the HWD 250 has rotated 20 degrees, the sensors 255 may determine that the HWD 250 now faces or is oriented in a direction 45 degrees from the reference direction. Assuming for another example that the HWD 250 was located two feet away from a reference point in a first direction, in response to detecting that the HWD 250 has moved three feet in a second direction, the sensors 255 may determine that the HWD 250 is now located at a vector multiplication of the two feet in the first direction and the three feet in the second direction.

In some embodiments, the sensors 255 include eye trackers. The eye trackers may include electronic components or a combination of electronic components and software components that determine a gaze direction of the user of the HWD 250. In some embodiments, the HWD 250, the console 210 or a combination of them may incorporate the gaze direction of the user of the HWD 250 to generate image data for artificial reality. In some embodiments, the eye trackers include two eye trackers, where each eye tracker captures an image of a corresponding eye and determines a gaze direction of the eye. In one example, the eye tracker determines an angular rotation of the eye, a translation of the eye, a change in the torsion of the eye, and/or a change in shape of the eye, according to the captured image of the eye, and determines the relative gaze direction with respect to the HWD 250, according to the determined angular rotation, translation and the change in the torsion of the eye. In one approach, the eye tracker may shine or project a predetermined reference or structured pattern on a portion of the eye, and capture an image of the eye to analyze the pattern projected on the portion of the eye to determine a relative gaze direction of the eye with respect to the HWD 250. In some embodiments, the eye trackers incorporate the orientation of the HWD 250 and the relative gaze direction with respect to the HWD 250 to determine a gate direction of the user. Assuming for an example that the HWD 250 is oriented at a direction 30 degrees from a reference direction, and the relative gaze direction of the HWD 250 is −10 degrees (or 350 degrees) with respect to the HWD 250, the eye trackers may determine that the gaze direction of the user is 20 degrees from the reference direction. In some embodiments, a user of the HWD 250 can configure the HWD 250 (e.g., via user settings) to enable or disable the eye trackers. In some embodiments, a user of the HWD 250 is prompted to enable or disable the eye trackers.

In some embodiments, the wireless interface 265 includes an electronic component or a combination of an electronic component and a software component that communicates with the console 210. The wireless interface 265 may be or correspond to the wireless interface 122. The wireless interface 265 may communicate with a wireless interface 215 of the console 210 through a wireless communication link through the base station 110. Through the communication link, the wireless interface 265 may transmit to the console 210 data indicating the determined location and/or orientation of the HWD 250, and/or the determined gaze direction of the user. Moreover, through the communication link, the wireless interface 265 may receive from the console 210 image data indicating or corresponding to an image to be rendered and additional data associated with the image.

In some embodiments, the processor 270 includes an electronic component or a combination of an electronic component and a software component that generates one or more images for display, for example, according to a change in view of the space of the artificial reality. In some embodiments, the processor 270 is implemented as a part of the processor 124 or is communicatively coupled to the processor 124. In some embodiments, the processor 270 is implemented as a processor (or a graphical processing unit (GPU)) that executes instructions to perform various functions described herein. The processor 270 may receive, through the wireless interface 265, image data describing an image of artificial reality to be rendered and additional data associated with the image, and render the image to display through the electronic display 275. In some embodiments, the image data from the console 210 may be encoded, and the processor 270 may decode the image data to render the image. In some embodiments, the processor 270 receives, from the console 210 in additional data, object information indicating virtual objects in the artificial reality space and depth information indicating depth (or distances from the HWD 250) of the virtual objects. In one aspect, according to the image of the artificial reality, object information, depth information from the console 210, and/or updated sensor measurements from the sensors 255, the processor 270 may perform shading, reprojection, and/or blending to update the image of the artificial reality to correspond to the updated location and/or orientation of the HWD 250. Assuming that a user rotated his head after the initial sensor measurements, rather than recreating the entire image responsive to the updated sensor measurements, the processor 270 may generate a small portion (e.g., 10%) of an image corresponding to an updated view within the artificial reality according to the updated sensor measurements, and append the portion to the image in the image data from the console 210 through reprojection. The processor 270 may perform shading and/or blending on the appended edges. Hence, without recreating the image of the artificial reality according to the updated sensor measurements, the processor 270 can generate the image of the artificial reality.

In some embodiments, the electronic display 275 is an electronic component that displays an image. The electronic display 275 may, for example, be a liquid crystal display or an organic light emitting diode display. The electronic display 275 may be a transparent display that allows the user to see through. In some embodiments, when the HWD 250 is worn by a user, the electronic display 275 is located proximate (e.g., less than 3 inches) to the user's eyes. In one aspect, the electronic display 275 emits or projects light towards the user's eyes according to image generated by the processor 270.

In some embodiments, the lens 280 is a mechanical component that alters received light from the electronic display 275. The lens 280 may magnify the light from the electronic display 275, and correct for optical error associated with the light. The lens 280 may be a Fresnel lens, a convex lens, a concave lens, a filter, or any suitable optical component that alters the light from the electronic display 275. Through the lens 280, light from the electronic display 275 can reach the pupils, such that the user can see the image displayed by the electronic display 275, despite the close proximity of the electronic display 275 to the eyes.

In some embodiments, the compensator 285 includes an electronic component or a combination of an electronic component and a software component that performs compensation to compensate for any distortions or aberrations. In one aspect, the lens 280 introduces optical aberrations such as a chromatic aberration, a pin-cushion distortion, barrel distortion, etc. The compensator 285 may determine a compensation (e.g., predistortion) to apply to the image to be rendered from the processor 270 to compensate for the distortions caused by the lens 280, and apply the determined compensation to the image from the processor 270. The compensator 285 may provide the predistorted image to the electronic display 275.

In some embodiments, the console 210 is an electronic component or a combination of an electronic component and a software component that provides content to be rendered to the HWD 250. In one aspect, the console 210 includes a wireless interface 215 and a processor 230. These components may operate together to determine a view (e.g., a FOV of the user) of the artificial reality corresponding to the location of the HWD 250 and the gaze direction of the user of the HWD 250, and can generate image data indicating an image of the artificial reality corresponding to the determined view. In addition, these components may operate together to generate additional data associated with the image. Additional data may be information associated with presenting or rendering the artificial reality other than the image of the artificial reality. Examples of additional data include, hand model data, mapping information for translating a location and an orientation of the HWD 250 in a physical space into a virtual space (or simultaneous localization and mapping (SLAM) data), eye tracking data, motion vector information, depth information, edge information, object information, etc. The console 210 may provide the image data and the additional data to the HWD 250 for presentation of the artificial reality. In other embodiments, the console 210 includes more, fewer, or different components than shown in FIG. 2. In some embodiments, the console 210 is integrated as part of the HWD 250.

In some embodiments, the wireless interface 215 is an electronic component or a combination of an electronic component and a software component that communicates with the HWD 250. The wireless interface 215 may be or correspond to the wireless interface 122. The wireless interface 215 may be a counterpart component to the wireless interface 265 to communicate through a communication link (e.g., wireless communication link). Through the communication link, the wireless interface 215 may receive from the HWD 250 data indicating the determined location and/or orientation of the HWD 250, and/or the determined gaze direction of the user. Moreover, through the communication link, the wireless interface 215 may transmit to the HWD 250 image data describing an image to be rendered and additional data associated with the image of the artificial reality.

The processor 230 can include or correspond to a component that generates content to be rendered according to the location and/or orientation of the HWD 250. In some embodiments, the processor 230 is implemented as a part of the processor 124 or is communicatively coupled to the processor 124. In some embodiments, the processor 230 may incorporate the gaze direction of the user of the HWD 250. In one aspect, the processor 230 determines a view of the artificial reality according to the location and/or orientation of the HWD 250. For example, the processor 230 maps the location of the HWD 250 in a physical space to a location within an artificial reality space, and determines a view of the artificial reality space along a direction corresponding to the mapped orientation from the mapped location in the artificial reality space. The processor 230 may generate image data describing an image of the determined view of the artificial reality space, and transmit the image data to the HWD 250 through the wireless interface 215. In some embodiments, the processor 230 may generate additional data including motion vector information, depth information, edge information, object information, hand model data, etc., associated with the image, and transmit the additional data together with the image data to the HWD 250 through the wireless interface 215. The processor 230 may encode the image data describing the image, and can transmit the encoded data to the HWD 250. In some embodiments, the processor 230 generates and provides the image data to the HWD 250 periodically (e.g., every 11 ms).

In one aspect, the process of detecting the location of the HWD 250 and the gaze direction of the user wearing the HWD 250, and rendering the image to the user should be performed within a frame time (e.g., 11 ms or 16 ms). A latency between a movement of the user wearing the HWD 250 and an image displayed corresponding to the user movement can cause judder, which may result in motion sickness and can degrade the user experience. In one aspect, the HWD 250 and the console 210 can prioritize communication for AR/VR, such that the latency between the movement of the user wearing the HWD 250 and the image displayed corresponding to the user movement can be presented within the frame time (e.g., 11 ms or 16 ms) to provide a seamless experience.

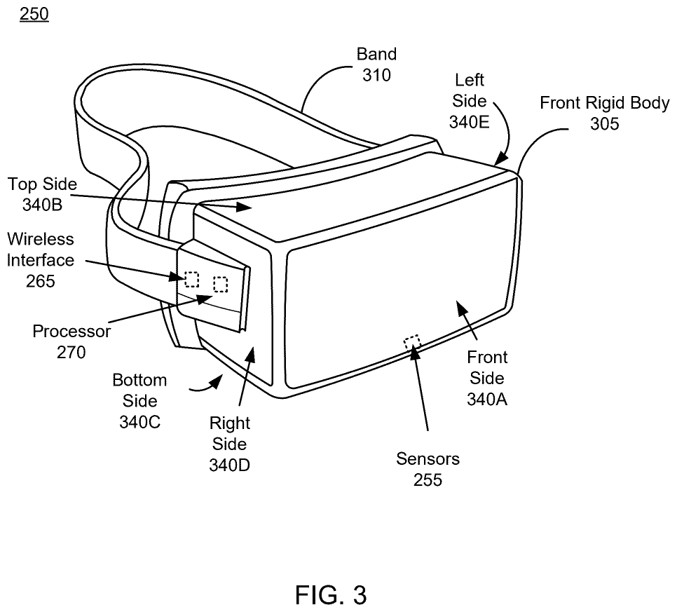

FIG. 3 is a diagram of a HWD 250, in accordance with an example embodiment. In some embodiments, the HWD 250 includes a front rigid body 305 and a band 310. The front rigid body 305 includes the electronic display 275 (not shown in FIG. 3), the lens 280 (not shown in FIG. 3), the sensors 255, the wireless interface 265, and the processor 270. In the embodiment shown by FIG. 3, the wireless interface 265, the processor 270, and the sensors 255 are located within the front rigid body 205, and may not be visible externally. In other embodiments, the HWD 250 has a different configuration than shown in FIG. 3. For example, the wireless interface 265, the processor 270, and/or the sensors 255 may be in different locations than shown in FIG. 3.

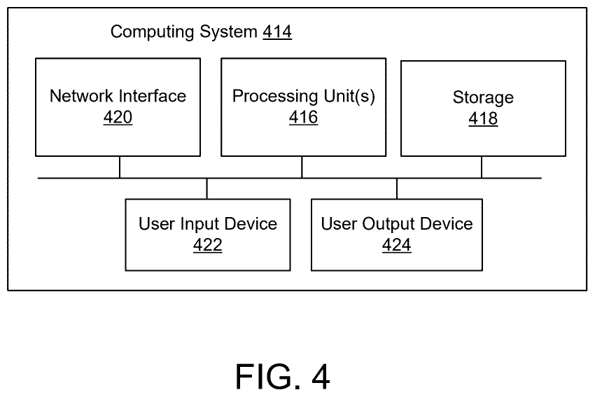

Various operations described herein can be implemented on computer systems. FIG. 4 shows a block diagram of a representative computing system 414 usable to implement the present disclosure. In some embodiments, the source devices 110, the sink device 120, the console 210, the HWD 250 are implemented by the computing system 414. Computing system 414 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 414 can be implemented to provide VR, AR, MR experience. In some embodiments, the computing system 414 can include conventional computer components such as processors 416, storage device 418, network interface 420, user input device 422, and user output device 424.

Network interface 420 can provide a connection to a wide area network (e.g., the Internet) to which WAN interface of a remote server system is also connected. Network interface 420 can include a wired interface (e.g., Ethernet) and/or a wireless interface implementing various RF data communication standards such as Wi-Fi, Bluetooth, or cellular data network standards (e.g., 3G, 4G, 5G, 60 GHz, LTE, etc.).

The network interface 420 may include a transceiver to allow the computing system 414 to transmit and receive data from a remote device using a transmitter and receiver. The transceiver may be configured to support transmission/reception supporting industry standards that enables bi-directional communication. An antenna may be attached to transceiver housing and electrically coupled to the transceiver. Additionally or alternatively, a multi-antenna array may be electrically coupled to the transceiver such that a plurality of beams pointing in distinct directions may facilitate in transmitting and/or receiving data.

A transmitter may be configured to wirelessly transmit frames, slots, or symbols generated by the processor unit 416. Similarly, a receiver may be configured to receive frames, slots or symbols and the processor unit 416 may be configured to process the frames. For example, the processor unit 416 can be configured to determine a type of frame and to process the frame and/or fields of the frame accordingly.

User input device 422 can include any device (or devices) via which a user can provide signals to computing system 414; computing system 414 can interpret the signals as indicative of particular user requests or information. User input device 422 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 424 can include any device via which computing system 414 can provide information to a user. For example, user output device 424 can include a display to display images generated by or delivered to computing system 414. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 424 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 416 can provide various functionality for computing system 414, including any of the functionality described herein as being performed by a server or client, or other functionality associated with message management services.

It will be appreciated that computing system 414 is illustrative and that variations and modifications are possible. Computer systems used in connection with the present disclosure can have other capabilities not specifically described here. Further, while computing system 414 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

Disclosed herein are related to systems and methods for link management in multi-link operation (MLO). MLO allows an access point (AP) and a non-AP device to establish a connection at one or more different physical mediums (hence forming “links” of MLO) at the medium access layer. According to the systems and methods described herein, a device may assign traffic profiles to links of multi-link devices using a traffic identifier (TID) to link mapping (TTLM) procedure to optimize usage of the medium.

For extended reality (XR), mixed reality (MR) and virtual reality (VR) use cases, several types of traffic may be transmitted between an MR/VR Headset and an AP. Different traffic types may have different characteristics that lend more to different transmission configurations. For example, sensor data may require frequent transmission of uplink data. In some examples, sensor data may require medium access 200-500 times per second. Sensor data may therefore achieve optimal performance when granted constant access to the medium, which may result in using power-saving methods like Target Wake Time (TWT) impractical or of no significant power saving benefit. TWT can allow an AP and STAs to schedule specific times for communication. This can help in reducing medium contention and the amount of time that a station in power-save mode needs to be awake. By negotiating TWT agreements, the AP and STAs can coordinate their wake-up times to exchange data efficiently. In contrast to the very frequent data from sensors etc., graphics data may be well-suited to power saving methods such as TWT because graphics data involves high data rate traffic streams that are predictable and evenly spaced apart in terms of arrival of traffic payloads. Likewise, certain traffic types may be better suited to certain link frequencies. For example, because graphics data involves high data rate traffic streams it may be better suited to high frequency links, such as a 6 GHz link, that support higher data rates.

The proposed XR optimized traffic identifier to link mapping (TTLM) solution with power save is to map, assign, or allocate traffic identifiers associated with different XR related traffic streams (e.g., graphics data, sensor data, and/or the like) to different links. In some implementations, data types may be mapped to links based on bandwidth and periodicity requirements. For example, a data type that requires high bandwidth may be mapped to high frequency links with less interference (e.g., 6 GHz). These systems may allow different types of traffic to be mapped to the most optimal link. In some examples, power saving methods such as TWT may be applied to one or more of the links. This proposed solution may allow devices to prioritize certain types of traffic and/or optimize power efficiency.

According to the systems and methods described herein, a multi-link device may identify two or more traffic streams. Each traffic stream may be associated with quality of service (QoS) parameters. The QoS parameters may include information such as required bandwidth, sensitivity to latency, prioritization, traffic identifiers, and/or the like. The multi-link device may assign, map, or allocate the traffic streams to one or more links of a plurality of links based on the QoS parameters of each traffic stream. In some examples, one or more links may use power saving methods such as TWT. The multi-link device may communicate the traffic streams to another multi-link device over the link that each traffic stream has been mapped to.

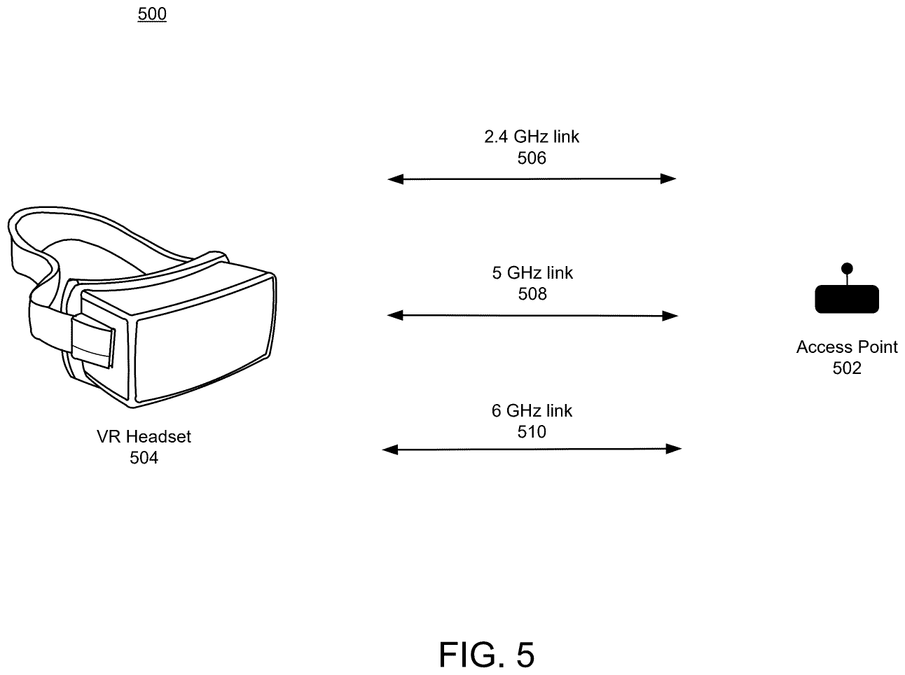

FIG. 5 is an example system 500 utilizing multiple links, according to an example implementation of the present disclosure. The system may include an access point 502, VR Headset 504, 2.4 GHz link 506, 5 GHz link 508, and 6 GHz link 510. The VR Headset 504 and the access point 502 may be similar to the devices, components, elements, or hardware described above with reference to FIG. 1-FIG. 4. For example, the VR Headset may be similar to the UEs 120, console 210, head wearable display 250, or any other form of user equipment. Additionally or alternatively, the access point 502 may be the same or similar to the base station 110. In some embodiments, the VR headset 504 may be an extended reality (XR) device that integrates real world elements, such as an augmented reality (AR) device or a mixed reality (MR) device. The access point 502 and the VR Headset 504 may include components, elements, hardware, etc. similar to the devices described above, such as processor(s) 124, memory 126, etc. The access point 502 and the VR Headset 504 may include hardware to support various wireless communication technology or technologies. For example, they may be configured for wireless local area network (WLAN) communication via one or more WLAN antennas or transceivers (e.g., WI-FI transceiver).

The access point 502 may allow wireless devices to connect to a network, such as a Wi-Fi network. In some examples, the access point 502 may manage traffic to optimize network resources and maintain consistent performance for associated non-AP devices. The VR Headset 504 may be a non-AP station. In some examples, the VR Headset 504 and the access point 502 may be configured for multi-link operation (MLO). The devices may be able to transmit data simultaneously using one or more frequency bands (e.g., the frequency bands forming “links” of MLO) for communication. Uplink (UL) data may be transmitted from the VR Headset 504 to the access point 502, and downlink data (DL) may be transmitted from the access point 502 to the VR Headset 504. The links illustrated in the figure include a 2.4. GHz link 506, 5 GHz link 508, and 6 GHz link 510. In some examples, only a subset of these links may be present. For example, data may be transmitted between the VR Headset 504 and the access point 502 via a 5 GHz link 508 and a 6 GHz link 510. In this example, the 2.4 GHz link may not be present. In other examples, additional links may be present. As an example, a 433 MHz link may additionally be present. In some examples, one or more links may utilize a power saving method (e.g., Target Wake Time (TWT), Low Power Listening (LPL), Wi-Fi power Save Mode (PSM), and/or the like). In an alternative embodiment, a second VR headset may be used in place of the access point 502. In this embodiment, the links (e.g., 2.4 GHz) may be peer-to-peer links.

The 2.4 GHz link 506 may have longer range and better penetration through physical objects such as walls. However, the 2.4. GHz link 506 may also have more interference from other devices than the other links. This link may be optimal for uses wherein stable connectivity over long distances is more important than high speed performance.

The 5 GHz link 508 may provide higher data rates than the 2.4 GHz link 506, resulting in higher Wi-Fi speeds. Additionally, this link may provide more channels and have less interference than the 2.4 GHz link. This link may be optimal for uses that require faster speeds and lower interference than the 2.4 GHz link can provide.

The 6 GHz link 510 may provide even more channels and less interference than the 5 GHz link. However, this link may struggle to penetrate physical objects more than even the 5 GHz link. This link may be optimal for uses wherein minimal interference and high throughout are most important.

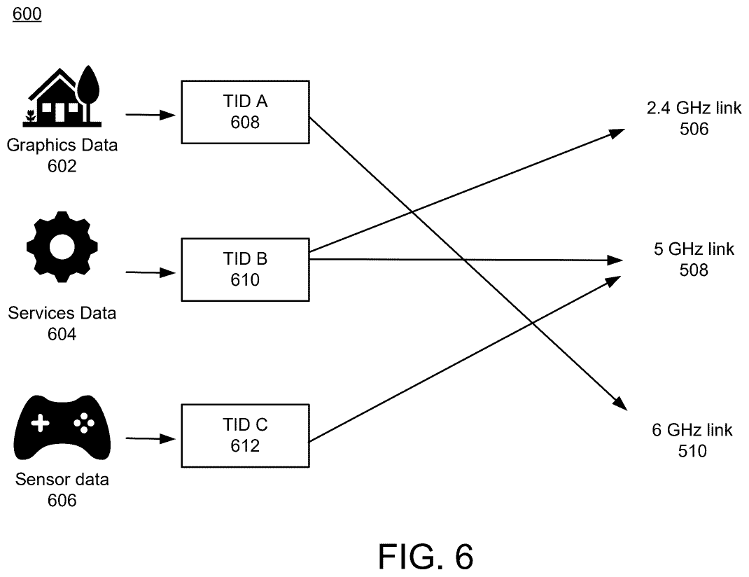

FIG. 6 is a diagram 600 of data types mapped to links, according to an example implementation of the present disclosure. In some examples, an VR headset (e.g., VR Headset 504) may be used to play a video game. The VR headset may transmit and receive data from an AP (e.g., access point 502 of FIG. 5). In some examples, the AP may receive VR game-related data from a processing device, such as a laptop. VR game-related data may include data types such as graphics data 602, services data 604, and/or sensor data 606. In response to receiving the VR game-related data, the AP may transmit downlink VR data to the VR headset. In these examples, the VR headset may generate and transmit uplink VR game-related data to the AP in response. In response to receiving the uplink VR game-related data from the VR headset, the AP may transmit the uplink VR game-related data to the processing device.

In some embodiments, the data types comprising the VR game-related data may be mapped to links based on QoS parameters associated with each data type. The QoS parameters may include information such as required bandwidth, periodicity, sensitivity to latency, prioritization, traffic identifiers, and/or the like. In some examples, QoS parameters may include information about minimum bandwidth required for acceptable performance (e.g., streaming a video may require 5 Mbps to avoid buffering). If a data type does not have access to the required bandwidth, it can lead to bottlenecks, slow data transfer, or dropped packets. As an example, QoS parameters associated with graphics data 602 may include a higher minimum bandwidth than QoS parameters associated with services data 604. In some examples, QoS parameters may include information about periodicity of the data flow associated with the data type. Periodicity may, for instance, indicate whether tasks are sporadic or occur as fixed intervals. As an example, graphics data 602 may be indicated to occur predictably at a certain fixed interval while sensor data 606 may be indicated to occur sporadically. In some implementations, a mapping of data types to links (e.g., such as that illustrated by FIG. 6) may be determined based on bandwidth and periodicity. As an example, the graphics data 602 may be the only data type mapped to the 6 GHz link 510 based on the graphics data 602 having a high bandwidth requirement. In this example, the services data 604 may be mapped to the 2.4 GHz link 506 based on the services data 604 having a low bandwidth requirement. Additionally or alternatively, power-saving methods may also be configured based on the QoS parameters. As an example, TWT may be applied to the 6 GHz link 510, as shown in FIG. 6, in response to determining that the graphics data 602 has a predictable data flow based on the periodicity indication included with the associated QoS parameters. Alternatively, the graphics data 602 may be assigned to the 6 GHz link 510 in response to determining that it has a predictable data flow and is therefore compatible with TWT.

VR game-related data may include graphics data 602. The graphics data 602 may include a sequence of frames, textures, shading details, and geometric information that collectively define the visual representation of a scene or object. When rendered, the graphics data 602 may replicate what a user may visually perceive if the game occurred in reality. The AP (e.g., access point 502 of FIG. 5) may transmit graphics data 602 to the VR headset. The graphics data 602 may be rendered as a video on a screen (e.g., electronic display 275 of FIG. 2) in the VR headset. Graphics data 602 may be latency-sensitive, since delays in processing or rendering may disrupt the real-time performance of visual outputs (e.g., resulting in visual lags that could be perceived by the user). As a result, QoS parameters associated with graphics data 602 may indicate that it requires a relatively high bandwidth for acceptable performance, has high priority, and/or the like. Transmitting graphics data 602 over higher frequency links may result in faster data rate transfers, which may ensure acceptable performance of the visual outputs. Since higher frequency links, such as the 6 GHz link, provide broader bandwidth and minimal interference, mapping the graphics data 602 to the 6 GHz link may result in more consistent performance of visual outputs. Additionally, in some examples the graphics data 602 may be well suited to power saving methods such as Target Wake Time (TWT) since the graphics data 602 may be transmitted predictably, and can therefore be scheduled for transmission. In some examples, the graphics data 602 may be determined to be predictable based on a periodicity indication included within associated QoS parameters. The graphics data may be assigned to a link that utilizes power saving methods based on the determination that it is predictable.

VR game-related data may include services data 604. In some examples, services data 604 may include function-related data, such as software updates or security patches. In other examples, services data 604 may include metadata that supports in-game activity. For example, this data can include metrics such as player progression, achievements, session duration, and in-game purchases. In some examples, services data 604 may be low priority because the services data 604 may not be significantly affected by latency, as it does not require immediate delivery and can tolerate delays without impacting overall system performance. The services data 604 may be identified as low priority and/or indicated to have a low bandwidth requirement based on associated QoS parameters. In examples wherein the services data 604 is low priority, it may be beneficial to map the services data 604 to a lower frequency link. The services data 604 may be transmitted on links with higher interference and lower data transfer speeds without significantly affecting system performance. Not mapping the services data 604 to the 6 GHz link 508 may also preserve the 6 GHz link's data transmission capacity for data that is more latency sensitive, such as the graphics data 602. Additionally, this may also allow services data 604 to be transmitted even when a physical object, such as a wall, separates the VR Headset 504 and the access point 502.

VR game-related data may include sensor data 606. Sensors (e.g., sensors 255 of FIG. 2) in the VR headset may generate sensor data 606 in response to detecting input from a user. For example, a user may move their head. A sensor (e.g., accelerometer, gyroscope, and/or the like) may determine a value associated with the movement, such as a change in position or a speed of movement. In this example, the sensor data 606 may comprise one or more values (e.g., a length in feet, an angle in degrees, and/or the like) determined by the sensor. As yet another example, the VR headset may be paired with a controller. The user may transmit input via the controller (e.g., through pressing a button, moving the controller, and/or the like). The VR headset may transmit the sensor data 606 to the AP in response to generating values in response to user input. In some examples, the graphics data 602 may be modified in response to the sensor data 606. As an example, sensor data 606 may be transmitted including values representing how much (e.g., an angle in degrees) a user has turned their head. In this example, graphics data 602 may change based on the sensor data 606 that represents how much the user has turned their head. This may mimic the change in what a person would see if they moved their head in real life. In the described example, the sensor data 606 representing how much a user has turned their head may be transmitted frequently (e.g., 200-500 times per second) to ensure that the change in graphics data 602 is highly responsive, just as change in field of vision would be in the tangible world. Furthermore, the sensor data 606 may have inconsistent data flow since it is based on user movement, which may be unpredictable. In some examples, the sensor data 606 may be determined to be unpredictable based an indication of periodicity included within associated QoS parameters. As a result of being unpredictable, the sensor data may be poorly suited to power saving methods, such as TWT. It may therefore be beneficial to assign the sensor data 606 to a link that does not use power saving methods. However, assigning the sensor data 606 to the 5 GHz link 508 may be more beneficial than assigning it to the 2.4 GHz link 506 due to the 5 GHz link 508 having higher bandwidth and lower latency. High bandwidth and low latency transmission may allow the VR headset to be highly responsive to the sensor data 606.

Each type of VR game-related data may be associated with quality of service (QoS) parameters that define performance characteristics and requirements for data transmission of the data type. For example, QoS parameters may identify latency sensitivity, priority level, acceptable packet loss, and/or maximum data rate allocated. As an example, the QoS parameters of the graphics data 602 may identify it as sensitive to latency. Additionally or alternatively, the QoS parameters may include a traffic identifier (TID). A group of TIDs associated with a group of data types may be used to classify and manage the group of data types. As shown in the illustrated FIG. 6., graphics data 602 is associated with TID A 608, services data 604 is associated with TID B 610, and sensor data 606 is associated with TID C 612. For example, TID A 608 may be assigned as TID 4 to classify the graphics data 602 as video traffic and TID C 612 may be assigned as TID 6 to identify the services data 604 as non-time-sensitive traffic.

In some embodiments, a data type may be assigned to a link using an associated TID. For example, the graphics data 602 may be mapped to the 5 GHz link 508 using the TID A 608. In some examples, an access point (e.g., access point 502 of FIG. 5) may determine a suitable link for a data type based on the QoS parameters associated with the data type. In response to determining that graphics data 602 has a high bandwidth requirement, the access point may map the TID A 608 to the 6 GHz link 510. In some examples, the link mapping may be performed by another devices, such as the VR headset (e.g., VR Headset 504). In some embodiments, a data type may be mapped to more than one link. As shown in the illustrated FIG. 6, the services data 604 is mapped to both the 2.4 GHz link 506 and the 5 GHz link 508. In this example, the services data 604 may be transmitted on a link based on one or more traffic conditions. For example, the services data 604 may be transmitted on the 2.4 GHz link in response to the 5 GHz link 508 being unavailable.

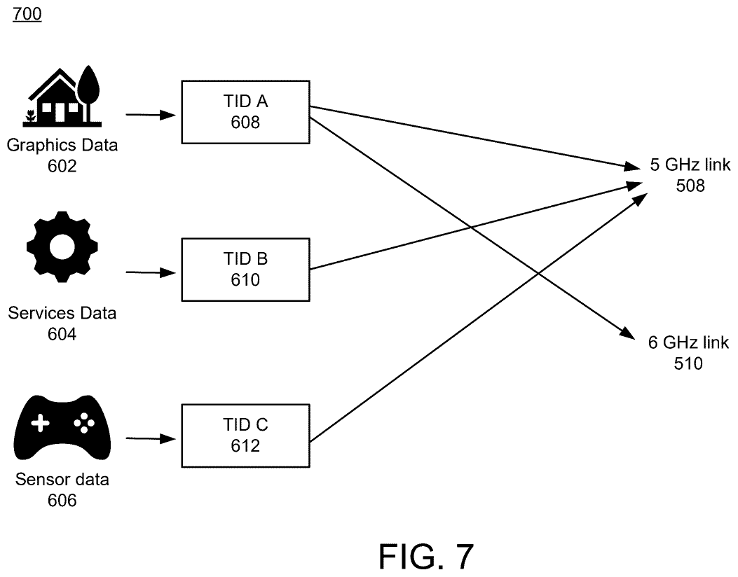

FIG. 7 is another diagram 700 of data types mapped to links, according to an example implementation of the present disclosure. As shown in this example, the graphics data 602, the services data 604, and the sensor data 606 of FIG. 6 may be mapped to the 5 GHz link 508. Additionally, the graphics data 602 may be mapped to the 6 GHz link 510. In some examples, the AP may assign only the graphics data 602, of the three data types illustrated in FIG. 6, to the 6 GHz in response to determining that the graphics data 602 has high priority. This determination may be based on QoS parameters associated with the graphics data 602. As a result, the graphics data 602 may be transmitted at a higher rate on this link due to there being less interference from other data types. Additionally or alternatively, the AP may assign the graphics data 602 to the 6 GHz link in response to determining that it is well suited to TWT power saving. In this example, the AP may apply a TWT schedule to the 6 GHz link 510. Additionally, the AP may assign the services data 604 and the sensor data 606 to the 5 GHz link in response to determining that they are not well suited to TWT power saving. As a result, one link that utilizes TWT power saving may be mapped to data types that are compatible with TWT power saving while another link that remains in an active mode (e.g., does not employ a TWT schedule) may be mapped to data types that are not compatible with TWT power saving. In alternative examples, TWT power saving may be used on all links. In some examples, the link mapping may be performed by another devices, such as the VR headset (e.g., VR Headset 504).

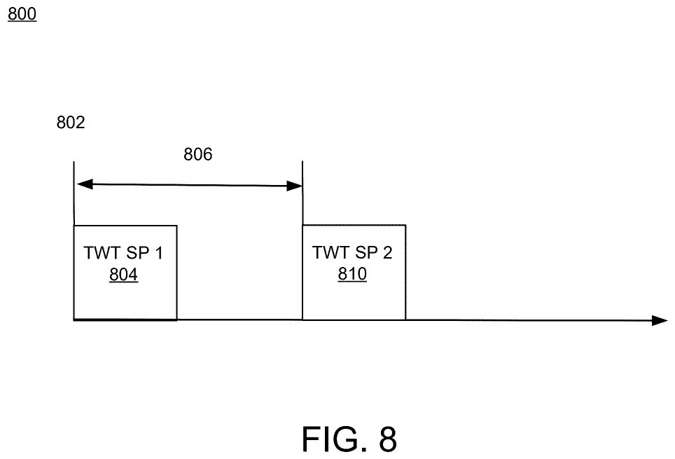

FIG. 8 is a timing diagram 800 showing a wake-up/sleep schedule of a computing device utilizing TWT, according to an example implementation of the present disclosure. The TWT start time is indicated by a device (e.g., access point 502, VR Headset 504, and/or the like) waking up (e.g., a portion of its relevant modules/circuitry) at 802. The device may wake up for a duration 806 defined by a SP. As shown, the device may wake up for the period shown by TWT SP 1 804. After the SP duration 806, the device may enter a sleep state until the next TWT start time at 808. At TWT start time 808, the device may wake up for a period shown by TWT SP 2 810. The interval of time between TWT start time 802 and TWT start time 808 may be considered the SP interval 806. In some examples, TWT as shown may be applied to one or more links (e.g., 2.4 GHz link 506, 5 GHz link 508, and/or 6 GHz link 510 of FIG. 5). In these examples, TWT may be applied to the one or more links in response to determining compatibility from QoS parameters associated with data types assigned to the links. By virtue of applying TWT to a link, power consumption may be reduced while maintaining efficient data transmission. As an example, TWT may be applied to the 6 GHz in response to determining that it is compatible with the graphics data 602 based on QoS parameters associated with the graphics data 602.

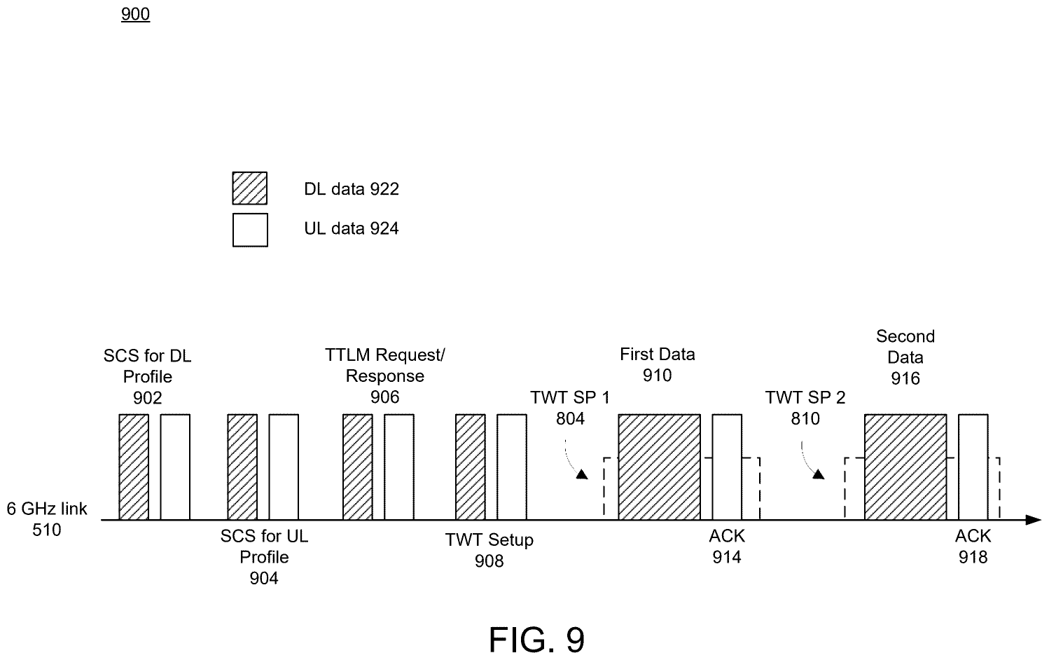

FIG. 9 is a timing diagram 900 showing a system configuring a data type to be sent over a link, according to an example implementation of the present disclosure. The illustrated example shows time domain interactions between a device transmitting downlink (DL) data 922 and a device transmitting uplink data 924 on the 6 GHz link 510. In some examples, an AP (e.g., access point 502 of FIG. 5) may transmit DL data 922 to a non-AP device (e.g., VR Headset 504). The non-AP device may also transmit uplink (UL) data 924 to the AP. A wireless link between the AP and the non-AP device over a wireless local area network (WLAN) may be established, thereby enabling communication and network access for the non-AP device. Based on interactions with the AP and the non-AP device, traffic settings may be configured on a link. For example, the illustrated device interactions of FIG. 9 may configure traffic settings such that graphics data (e.g., graphics data 602 of FIG. 6) is transmitted over the 6 GHz link using target wake time (TWT) power saving.

In some examples, stream classification service (SCS) may be utilized to configure one or more downlink traffic settings of a link. SCS can allow a stream to be classified to a user priority, enhanced distributed channel access (EDCA) access category (AC), and drop eligibility indicator (DEI). This service can be designed to enhance QoS by classifying and prioritizing specific traffic flows, such as gaming, voice, and video, over bulk data traffic.

In some examples, the AP may initiate SCS. As shown in the illustrated FIG. 9, the AP may transmit DL data 922 to initiate SCS for DL profile (e.g., types of DL traffic) 902. In some examples, the AP may transmit control information to configure SCS for DL profile 902. For example, the control information may include scheduling configuration information (e.g., time-domain resource assignment and/or the like) and/or QoS parameters (e.g., priority levels and/or the like). In response to the downlink data, the non-AP device may transmit UL data 924. In this example, the UL data 924 may provide response information about configuration of traffic settings. In some examples, the DL data 922 may include traffic type information indicating what types of data the non-AP device may receive from the AP. As an example, the traffic type information may indicate that the non-AP device may receive graphics data (e.g., graphics data 602 of FIG. 6), services data (e.g., services data 604 of FIG. 6), and/or sensor data (e.g., sensor data 606 of FIG. 6). Additionally or alternatively, the DL data 922 may include QoS data associated with traffic types that the non-AP device may receive. DL data for a traffic type may be mapped to a link based on the QoS data including a TID associated with a traffic type. For example, DL data associated with TID 4 (e.g., graphics data) may be mapped to the 6 GHz link 510. It will be noted that in some examples, DL and UL data for a traffic type may be mapped to different links. As an example, DL graphics data may be mapped to the 6 GHz link 510, while UL graphics data may be mapped to the 5 GHz link 508 of FIG. 5.

SCS for UL profile (e.g., types of UL traffic) 904 may be configured similarly. The UL data 924 transmitted as part of SCS for UL profile 904 may include information on what types of traffic the non-AP device may transmit to the AP. As an example, the traffic type information may indicate that the non-AP device may receive graphics data (e.g., graphics data 602 of FIG. 6), services data (e.g., services data 604 of FIG. 6), and/or sensor data (e.g., sensor data 606 of FIG. 6). Similar to configuration of the DL profile, UL data 924 may include QoS data associated with data types that the AP device may receive from the non-AP device. As part of configuring the SCS for UL profile 904, UL data for a TID associated with a traffic type may be mapped to a link. For example, UL data associated with TID 4 (e.g., graphics data) may be associated with the 6 GHz link 510. In some examples, the SCS for UL profile 904 may not be configured. In these examples, the UL data may be less complex than the DL data. As an example, the DL data (e.g., first data 910) may include graphics frames while the UL data (e.g., ACK 914) may be an acknowledgement of the DL data. In this example, because the UL data is less complex and/or less critical, it may not be configured. In some examples, the UL profile may follow the same configuration as the DL profile.

To assign data types to links, the AP may utilize TID to link mapping (TTLM). In some examples, the non-AP device may transmit information about TIDs associated with data types as part of configuring the SCS for DL profile and the UL profile. As an example, the non-AP device may transmit that TID 4 (e.g., TID A 608 of FIG. 6) is associated with the graphics data while configuring the SCS for DL profile 902 and/or the SCS for UL profile 904. The AP may utilize the TIDs associated with the data types to match each data type to one or more links. As part of the TTLM Request/Response 906, the AP may transmit DL data 922 to the non-AP device including information about which data type is to be mapped to which link. Additionally or alternatively, the DL data 922 transmitted as part of the TTLM request/response 906 may request information related to TTLM from the non-AP device and/or provide information upon which the non-AP device may determine a TTLM configuration. The non-AP device may transmit an acknowledgement (e.g., ACK block and/or the like) to a configuration determined by the AP in the UL data 924 in the TTLM request/response 906. Additionally or alternatively, the non-AP device may determine a configuration of data types to available links and transmit this information as part of the UL data 924 in the TTLM request/response 906.

In some examples, it may be determined that a power saving method should be applied to a link. For example, the power saving method may be applied in response to assigning one or more data types to the link that are compatible with power saving methods. In an example wherein the graphics data is assigned to the 6 GHz link, TWT may be applied to the link based on determining that graphics data is compatible with TWT power saving. This determination may be made by the AP and/or non-AP STA. As part of TWT setup 908, the AP may transmit DL data 922 to the non-AP device. The DL data 922 may include an indication that TWT power saving will be used on the 6 GHz link 510 and/or a schedule for wake times. The non-AP may transmit UL data 924 in response to the DL data 922 transmitted as part of the TWT setup 908. The UL data 924 may include an acknowledgement of the DL data 922 and/or an indication of preferences or QoS requirements of the non-AP device. In some examples, the TWT schedule may be further configured based on the UL data 924 received by the AP as part of the TWT setup 908. In some examples, a specific type of TWT may be applied. As an example, individual target wake time (iTWT) may be applied to allow the non-AP device to schedule its wake time. iTWT can improve power efficiency and reduce contention by allowing each STA to wake up at specific times to transmit or receive data. iTWT can help in managing power consumption and ensuring that devices only wake up when necessary, which is particularly useful in environments with multiple devices. In this example, the non-AP device may transmit data to schedule its wake time as part of the UL data 924 in the TWT setup 908. As another example, restricted target wake time (R-TWT) may be applied to allow the AP to schedule the wake times of devices to optimize transmission over the link for a group of devices. R-TWT can reserve specific time intervals for particular STAs, ensuring that these stations can transmit data without experiencing contention from other devices. In this example, the AP may determine the wake time for the non-AP device in response to allocating a various wake times to one or more other devices. The wake time information for R-TWT may be transmitted as part of the DL data 922 in the TWT setup 908.

In response to configuring the SCS for DL profile 902, SCS for UL profile, TTLM request/response 906, and TWT setup 908, data may be transmitted according to a TWT schedule. At TWT SP 1 804, the non-AP device may wake up for a period of time specified by the TWT SP 1 804. During TWT SP 1 804, the non-AP may receive first data 910 from the AP. In some examples, the first data 910 may be graphics data. In response to receiving the first data 910, the non-AP device may transmit ACK 914 to the AP to acknowledge transmission of the first data 910. Once the TWT SP 1 804 has ended, the non-AP device may enter a sleep state until the start TWT SP 2 810. At the start of TWT SP 2 810, the non-AP device may receive second data 916. Similar to the first data 910, the second data 916 may include graphics data. In response to receiving second data 916, the non-AP device may transmit ACK 918 to the AP. Once the TWT SP 2 810 has ended, the non-AP device may enter a sleep state until the start of the next SP, at which the TWT process (e.g., as described in this figure and/or FIG. 8), may repeat.

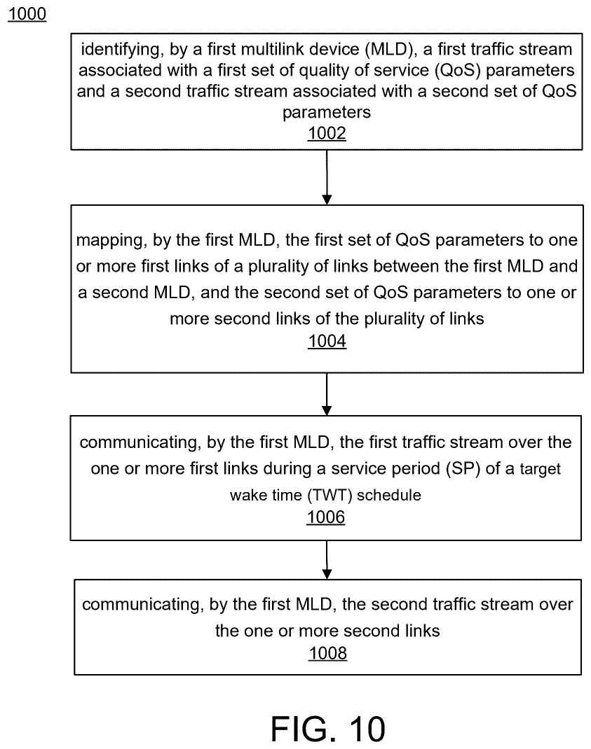

FIG. 10 is a flowchart 1000 showing an example method of mapping traffic identifiers to links, according to an example implementation of the present disclosure. In some embodiments the method may be performed by a first multi-link device (MLD). The first multi-link device may be capable of transmitting data to a second MLD on one or more links (e.g., 2.4 GHz link 506, 5 GHz link 508, and 6 GHz link 510). In some examples, the first MLD may include an access point (AP) (e.g., access point 502 of FIG. 5). In some examples, the second MLD may include a non-AP MLD (e.g., VR Headset 504). As an alternative example, the first MLD may include a non-AP MLD and the second MLD may include an AP MLD. As yet another alternative example, both the first MLD and the second MLD may include a non-AP MLD. In this example, the described links between the first MLD and the second MLD may be peer-to-peer links.

At step 1002, the first MLD may identify traffic streams. The traffic streams (graphics data 602, services data 604, and sensor data 606 of FIG. 6) may be associated with data transmitted to and/or from the second MLD. The first MLD may identify a first traffic stream associated with a first set of quality of services (QoS) parameters. The QoS may include information such as required bandwidth, periodicity, sensitivity to latency, prioritization, and/or the like. In some examples, the first MLD may identify at least one other traffic stream. For example, the first MLD may identify a second traffic stream associated with a second set of QoS parameters. In some examples the first traffic stream and/or second traffic stream may include two or more types of data. As an example, the second traffic stream may include both services data (e.g., services data 604 of FIG. 6) and sensor data (e.g., sensor data 606 of FIG. 6).

In some embodiments, the first set of QoS parameters may be associated with one or more first traffic identifier (TIDs). As an example, the graphics data 602 of FIG. 6 may be associated with TID A 608 of FIG. 6. As illustrated in FIG. 6, TID A may be mapped to the 6 GHz link 510. Similar to the first set of QoS parameters, the second set of QoS parameters may be associated with one or more second TIDs. As an example, the second traffic stream may include services data 604 of FIG. 6 be associated with TID B 610 of FIG. 6. By associating TID B with the 2.4 GHz link, the services data may be mapped to the 2.4 GHz link. In some examples, the one or more first TIDs may be a single TID. As an example, the first traffic stream may include graphics data (e.g., graphics data 602 of FIG. 6) and be mapped to a single TID associated with the graphics data (e.g., TID A 608). In some examples, the one or more second TIDs may include two or more TIDs. As an example, the second traffic stream may include services data (e.g., services data 604 of FIG. 6) and sensor data (e.g., sensor data 606 of FIG. 6) and be mapped to a TID associated with the services data (e.g., TID B 610 of FIG. 6) and a TID associated with the sensor data (e.g., TID C 612 of FIG. 6).

In some examples, the first traffic stream may be identified as latency sensitive based on the associated first set of QoS parameters. In these examples, the first set of QoS parameters may relate to latency sensitive traffic. For example, the first set of QoS parameters may include a priority level, a latency requirement, a jitter tolerance, and/or the like. In some examples, the second traffic stream may be identified as not latency sensitive based on the second set of QoS parameters. In these examples, the second set of QoS parameters may relate to traffic other than latency sensitive traffic. In an example wherein the first traffic stream includes graphics data, QoS parameters associated with the graphics data may identify it as latency sensitive because latency may impact the quality of video rendered based on the graphics data. In an example wherein the second traffic stream includes services data, QoS parameters associated with the services data may identify it as not latency sensitive because services data such as software updates may tolerate delays without significant impact on performance.

In some embodiments, the first and second set may include a bandwidth indication. For example, this indication may give a bandwidth requirement for acceptable performance. As an example, the QoS parameters associated with graphics data (e.g., graphics data 602 of FIG. 6) may include a minimum bandwidth at which the video rendered based on the graphics data is of an acceptable quality. Bandwidth requirements play a critical role in ensuring optimal performance, as insufficient bandwidth can lead to bottlenecks, slow data transfer, or dropped packets, which can impact performance. In implementations, the bandwidth included in the first set of QoS parameters may be different from the bandwidth included in the second set of QoS parameters. As an example, the bandwidth included in QoS parameters associated with graphics data (e.g., graphics data 602 of FIG. 6) may be different than the bandwidth included in QoS parameters associated with services data (e.g., services data 604 of FIG. 6). In this example, the graphics data may have a higher required bandwidth for acceptable performance (e.g., video quality) than the services data may have for acceptable performance (e.g., timeliness of software updates). In described embodiments, the first and second set of QoS parameters may also include periodicity indications. For example, this indication may give timing information and/or frequency of data flow associated with the data type. As an example, the QoS parameters associated with sensor data (e.g., sensor data 606 of FIG. 6) may indicate that data flow is frequent and inconsistent. In some implementations, the periodicity included in the first set of QoS parameters may be different from the periodicity included in the second set of QoS parameters. As an example, the periodicity included in QoS parameters associated with graphics data may be different than the periodicity included in QoS parameters associated with sensor data. In this example, the graphics data may be indicated to be predictable while the sensor data may be indicated to be unpredictable.

In some embodiments, the second traffic stream may be identified based on an interval size. For example, the second traffic stream may be identified from one or more types of traffic transmitted between the first MLD and the second MLD. The second traffic stream may be identified as associated with the second set of QoS parameters in response to determining that traffic associated with the second set of QoS parameters has an interval smaller than a threshold (e.g., 2 ms). Traffic that requires frequent (e.g., relatively small interval) transmission may be poorly suited to TWT power saving, as the interval between wake times may introduce delays that negatively impact performance. The first MLD may identify, based on QoS parameters, that certain traffic types have relatively small intervals, and should therefore not be assigned to a link that utilizes TWT. In some examples, the first MLD may maintain one or more links in active mode (e.g., may not apply TWT to the link) for traffic types that are poorly suited to TWT. For example, the first MLD may maintain the one or more second links in active mode. This may allow the first MLD to assign traffic streams that are well-suited to TWT to a link that utilizes TWT and assign traffic streams that are poorly-suited to TWT to a link that is always in an active state. As a result, the first MLD may determine a TTLM that enables more efficient utilization of the links.

At step 1004, the first MLD may map the first and second set of QoS parameters to one or more links. One or more links (e.g., 2.4 GHz link 506 of FIG. 5, 5 GHz link 508 of FIG. 5, and 6 GHz link 510 of FIG. 5) may exist between the first MLD and the second MLD. The first MLD may determine a mapping between the sets of QoS parameters and the links that results in optimal use of the links. For example, the first MLD may map the first set of QoS parameters to one or more first links of the plurality of links and the second set of QoS parameters to one or more second links of the plurality of links. In some examples, the sets of QoS parameters may be assigned mappings by associating a TID included as part of the QoS parameters with one or more links of the plurality of links. The mappings may be assigned to optimize use of available links based on bandwidth requirements and/or periodicity indications included in the first and second set of QoS parameters.

In some embodiments, a set of QoS parameters may be mapped to a single link or a plurality of links. For example, the one or more first links may be a single link of the plurality of links between the first MLD and the second MLD. As an example, with reference to the illustrated FIG. 6, the graphics data 602 may be mapped to just the 6 GHz link 510. In this example, the first traffic stream may be associated with the graphics data, and as a result the one or more first links may only include the 6 GHz link. This may allow latency sensitive data, such as graphics data, to be mapped to a link with less interference. In some examples, the one or more second links may be two or more links of the plurality of links between the first MLD and the second MLD. As an example, with reference to the illustrated FIG. 6, the sensor data 606 is mapped to the 5 GHz link 508 and the services data 604 is mapped to the 2.4 GHz link 506. In this example, the second traffic stream may be associated with both the sensor data and the services data, and as a result, the one or more second links may include the 5 GHz link and the 2.4 GHz link.

Mapping QoS parameters to one of more links may include associating a set of QoS parameters with a TWT schedule. For example, the first set of QoS parameters may be associated with a TWT schedule. The first MLD may associate the first set of QoS parameters with the TWT schedule in response to determining that the first set of QoS parameters are compatible with the TWT schedule. In an example wherein the first set of QoS parameters are associated with graphics data, the first MLD may associate the first set of QoS parameters with the TWT schedule in response to determining that the graphics data is transmitted predictably in periodic intervals. In an example, the first MLD may determine that the graphics data is typically transmitted in periodic intervals based on the first set of QoS parameters. In response to associating the first set of QoS parameters with the TWT schedule, the first MLD may perform a TTLM procedure to map the one or more first TIDs to the one or more first links. As an example, the first MLD may map graphics QoS parameters associated with graphics data to the 6 GHz link in response to associating the graphics QoS parameters with the TWT schedule.

In some embodiments, a stream classification service (SCS) procedure may be performed to associate the first set of QoS parameters with the one or more first TIDs. As an example, with reference to FIG. 9, the first MLD and the second MLD may transmit downlink (DL) and uplink (UL) data to each other to perform an SCS for DL profile 902 and/or an SCS for UL profile 904. As part of configuring the SCS for DL profile 902, the first MLD may transmit control information associated with DL data, such as QoS parameters. Similarly, as part of configuring the SCS for UL profile 904, the second MLD may transmit UL data, such as QoS parameters. Based on the UL and DL data exchanged as part of configuring the SCS for DL profile 902 and the SCS for UL profile 904, the first MLD may map QoS parameters associated with a stream of traffic to one or more links. The MLD may map QoS parameters in a manner that efficiently uses available links. For example, in response to determining from the SCS procedure that DL graphics data is latency sensitive, the first MLD may map a set of QoS parameters associated with the DL graphics data to the 6 GHz link.

At step 1006, the first MLD may communicate the first traffic stream over one or more first links. In some examples, the one or more first links may be configured with TWT. As a result, the first traffic stream may be communicated over the one or more first links during a service period (SP) of a target wake time (TWT) schedule. As an example, the first traffic stream may be communicated during TWT SP 1 804 of FIG. 8. For example, the first traffic stream may comprise graphics data. In this example, the graphics data may be mapped to the 6 GHz link based on QoS parameters associated with the first traffic stream by assigning a TID associated with the graphics data to the 6 GHz link. As a result, the first MLD may communicate graphics data comprising frames to the second MLD via the 6 GHz link during an SP.

At step 1008, the first MLD may communicate the second traffic stream over one or more second links. In some examples, the one or more second links may not be configured with TWT. As a result, the one or more second links may remain in an active state. As an example, the second traffic stream may comprise both services data and sensor data. The MLD may identify the services data and the sensor as the second traffic stream in response to determining, from the associated QoS parameters, that they are not latency-sensitive traffic. In this example, the services data may be mapped to the 2.4 GHz link and 5 GHz based on QoS parameters associated with the services data by assigning an associated TID to the 2.4 GHz link and the 5 GHz link. Similarly, the sensor data may also be mapped to the 5 GHz link based on QoS parameters associated with the sensor data by assigning an associated TID to the 5 GHz link. As a result, the first MLD and/or second MLD may communicate services data, such as a software update, via either the 2.4 GHz link or the 5 GHz link and sensor data, such as a change in position of a user, via the 5 GHz link.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method comprising:
identifying, by a first multi-link device (MLD), a first traffic stream associated with a first set of quality of service (QoS) parameters and a second traffic stream associated with a second set of QoS parameters;
mapping, by the first MLD, the first set of QoS parameters to one or more first links of a plurality of links between the first MLD and a second MLD, and the second set of QoS parameters to one or more second links of the plurality of links;
communicating, by the first MLD, the first traffic stream over the one or more first links during a service period (SP) of a target wake time (TWT) schedule; and
communicating, by the first MLD, the second traffic stream over the one or more second links.

2. The method of claim 1, wherein:
the first set of QoS parameters include a bandwidth different from a bandwidth included in the second set of QoS parameters; or
the first set of QoS parameters include periodicity different from periodicity included in the second set of QoS parameters.

3. The method of claim 1, wherein:
the first MLD comprises one of an access point (AP) MLD and a non-AP MLD, and the second MLD comprises the other of the AP and the non-AP MLD; or
each of the first MLD and the second MLD comprises a non-AP MLD.

4. The method of claim 1, wherein:
the one or more first links are a single link of the plurality of links, and
the one or more second links include two or more links of the plurality of links.

5. The method of claim 1, wherein:
the first set of QoS parameters are associated with one or more first traffic identifier (TIDs), and
the second set of QoS parameters are associated with one or more second TIDs.

6. The method of claim 5, wherein mapping the first set of QoS parameters to the one or more first links comprises:
associating the first set of QoS parameters with a TWT schedule; and
performing a TID to link mapping (TTLM) procedure to map the one or more first TIDs to the one or more first links.

7. The method of claim 5, wherein mapping the first set of QoS parameters to the one or more first links comprises:
performing a stream classification service (SCS) procedure to associate the first set of QoS parameters with the one or more first TIDs.

8. The method of claim 5, wherein:
the one or more first TIDs are a single TID, and
the one or more second TIDs include two or more TIDs.

9. The method of claim 1, further comprising:
maintaining the one or more second links in an active mode.

10. The method of claim 1, wherein identifying the second traffic stream comprises:
determining whether the second traffic stream has an interval smaller than a threshold; and
in response to the second traffic stream having an interval smaller than the threshold, identifying the second traffic stream associated with the second set of QoS parameters.

11. A first multi-link device (MLD) comprising one or more processors configured to:
identify a first traffic stream associated with a first set of quality of service (QoS) parameters and a second traffic stream associated with a second set of QoS parameters;
map the first set of QoS parameters to one or more first links of a plurality of links between the first MLD and a second MLD, and the second set of QoS parameters to one or more second links of the plurality of links;
communicate the first traffic stream over the one or more first links during a service period (SP) of a target wake time (TWT) schedule; and
communicate the second traffic stream over the one or more second links.

12. The first MLD of claim 11, wherein:
the first set of QoS parameters include a bandwidth different from a bandwidth included in the second set of QoS parameters; or
the first set of QoS parameters include periodicity different from periodicity included in the second set of QoS parameters.

13. The first MLD of claim 11, wherein:
the first MLD comprises one of an access point (AP) MLD and a non-AP MLD, and the second MLD comprises the other of the AP and the non-AP MLD; or
each of the first MLD and the second MLD comprises a non-AP MLD.

14. The first MLD of claim 11, wherein:
the one or more first links are a single link of the plurality of links, and
the one or more second links include two or more links of the plurality of links.

15. The first MLD of claim 11, wherein:
the first set of QoS parameters are associated with one or more first traffic identifier (TIDs), and
the second set of QoS parameters are associated with one or more second TIDs.

16. The first MLD of claim 15, wherein in mapping the first set of QoS parameters to the one or more first links, the one or more processors are configured to:
associate the first set of QoS parameters with a TWT schedule; and
perform a TID to link mapping (TTLM) procedure to map the one or more first TIDs to the one or more first links.

17. The first MLD of claim 15, wherein in mapping the first set of QoS parameters to the one or more first links, the one or more processors are configured to:
perform a stream classification service (SCS) procedure to associate the first set of QoS parameters with the one or more first TIDs.

18. The first MLD of claim 15, wherein:
the one or more first TIDs are a single TID, and
the one or more second TIDs include two or more TIDs.

19. The first MLD of claim 11, wherein the one or more processors are configured to:
maintain the one or more second links in an active mode.

20. The first MLD of claim 11, wherein in identifying the second traffic stream, the one or more processors are configured to:
determine whether the second traffic stream has an interval smaller than a threshold; and
in response to the second traffic stream having an interval smaller than the threshold, identify the second traffic stream associated with the second set of QoS parameters.
